(19) United States
(12) Patent Application Publication
(10) Pub. No.: US 2018/0316804 A1
(43) Pub. Date: Nov. 1, 2018

(54) EPAPER DISPLAY PRINTER

(71) Applicant: Christine Reina, (US)

(72) Inventors: Christine Reina, Bridgehampton, NY (US); Pawel Aksamit, Opole (PL)

(73) Assignee: Christine Reina, Bridgehampton, NY (US)

(21) Appl. No.: 15/802,212

(22) Filed: Nov. 2, 2017

Related U.S. Application Data
(63) Continuation of application No. 15/582,070, filed on Apr. 28, 2017.

(51) Int. Cl. H04N 1/00; H01M 10/052; G06F 3/041; H01M 10/04

(52) U.S. Cl. CPC H04N 1/00228; H01M 2220/30; G06F 2203/04102; H04N 2201/0065; H04N 2201/0055; H04N 2201/0089; H01M 10/0436; H01M 10/052; H04N 1/00344; G06F 3/041; H04N 1/00233

(57) ABSTRACT

A handheld device that includes a display; a wireless communication module; and display services. The display services are configured to: (i) receive visually perceptible elements in a first format from print services installed in a computing device; (ii) convert the visually perceptible elements in the first format into a second format, the second format sizing the visually perceptible elements relatively to the size of the display, so that the visually perceptible elements fit on the display in relative sizes and positions identical as visually perceptible elements would have appeared on a paper substrate; (iii) display a first page of the visually perceptible elements in the second format on the display of the handheld device; and (iv) after receiving a next page command, display a next page of visually perceptible elements in the second format on the display of the handheld device.

### CROSS REFERENCE TO RELATED APPLICATIONS

This application is a continuation of U.S. patent application Ser. No. 15/582,070 filed on Apr. 28, 2017, which is pending. The patent application identified above is incorporated here by reference in its entirety to provide continuity of disclosure.

### BACKGROUND

The present invention relates to systems and methods of replacing conventional printing paper with another means of visualizing data.

Conventional printing systems comprise a printer with a printhead adapted to create an image on a paper sheet. The technology behind creating image on a paper may be, for example ink-based or laser-based. In each case printing involves a consumption of materials (ink or toner cartridge) as well as paper.

Many times, printouts are made just for a single use, because it is inconvenient to read from a computer screen, especially when there is a need to make notes or sketching on the text. This way of working with documents is very costly and harmful for the environment. Thus, alternative methods and systems for working with documents are needed. Such methods and systems should provide a user with an experience like working with conventional printing paper, but without the consumption of ink/toner and paper.

There are solutions known utilizing an electronic paper screen, like Kindle™ e-book reader or reMarkable (described by its producer as “the paper tablet”). Those solutions however do not provide an experience like working with a real paper, because they do not allow printing directly from any computer-implemented application into their screen. They are also not elastic like a conventional printing paper, which makes a difference for someone working with lots of documents, for a long time, and parallelly using other devices, like e.g. a phone or a computer.

If any solution is to replace conventional paper it must be convenient to use and approachable. No product available today provides a comprehensive solution that would have all the features needed for a solution to be as convenient to use as conventional paper.

### SUMMARY

The disclosed technology recognized the above frustrations within the printer marketplace and has overcome this frustration by developing an electronic paper display printer that can replace conventional printers.

In one implementation, a system can comprise: (a) a computing device having print services installed thereon; (b) at least one handheld device, being in wireless communication with the computing device; and (c) display services, the print services programmed to: (i) receive a print task from an application being operated by the computing device, the print task defining a plurality of visually perceptible elements; (ii) convert the plurality of visually perceptible elements included in the print task from a first format to a second format; and (iii) send the plurality of visually perceptible elements in the second format to the display services; and the display services programmed to: (i) receive the plurality of visually perceptible elements in the second format; (ii) convert the plurality of visually perceptible elements in the second format into a third format, the third format sizing the plurality of visually perceptible elements relatively to the size of a display of the handheld device, so that the plurality of visually perceptible elements fit on the display in relative sizes and positions identical as the plurality of visually perceptible elements would have appeared on a paper substrate; (iii) display a first page of the plurality of visually perceptible elements in the third format on the display of the handheld device; and (iv) after receiving a next page command, display a next page of the plurality of visually perceptible elements in the third format on the display of the handheld device.

In some implementations, the display can be a flexible display, e.g., a polymide plastic thin-film transistor. In some implementations, the display includes a touch-sensitive layer. In some implementations, the display includes a graphical user interface having control buttons. In some implementations, the plurality of visually perceptible elements are divided into one or more pages for presentation.

In some implementations, the next page command is performed with a swipe function of the touch-sensitive layer. In some implementations, the wireless communication is one of WiFi or Bluetooth. In some implementations, the at least one handheld device includes a flexible battery, e.g., two carbon nanotubes-lithium oxide composites yarns wound together. In another implementation, a handheld device can comprise: (a) a display; (b) a wireless communication module; and (c) display services, the display services configured to: (i) receive a plurality of visually perceptible elements in a first format from print services installed in a computing device; (ii) convert the plurality of visually perceptible elements in the first format into a second format, the second format sizing the plurality of visually perceptible elements relatively to the size of the display, so that the plurality of visually perceptible elements fit on the display in relative sizes and positions identical as the plurality of visually perceptible elements would have appeared on a paper substrate; (iii) display a first page of the plurality of visually perceptible elements in the second format on the display of the handheld device; and (iv) after receiving a next page command, display a next page of the plurality of visually perceptible elements in the second format on the display of the handheld device.

### BRIEF DESCRIPTION OF DRAWINGS

FIG. 1 illustrates an exemplary embodiment of the disclosed technology;

FIG. 2 illustrates an exemplary configuration of a computing device of the disclosed technology;

FIG. 3 presents an exemplary embodiment of the print services of the disclosed technology;

FIG. 4 presents an exemplary embodiment of the print services according to Mac OSX architecture;

FIG. 5 illustrates an exemplary embodiment of the print services according to Windows architecture;

FIG. 6 presents exemplary display services residing in a computing device of the disclosed technology;

FIG. 7 illustrates an exemplary view of a user interface the display services residing in the computing device of the disclosed technology;

FIG. 8 illustrates an exemplary embodiment, where the display services are part of the print services of the disclosed technology;

FIG. 9 illustrates an exemplary configuration of a handheld device of the disclosed technology;

FIG. 10 illustrates an exemplary, non-flexible physical embodiment of a handheld device of the disclosed technology;

FIG. 11 illustrates an exemplary flexible physical embodiment of a handheld device of the disclosed technology;

FIG. 12 illustrates exemplary display services residing in a handheld device of the disclosed technology; and

FIG. 13 illustrates exemplary display services residing partly in a computing device and partly in a handheld device of the disclosed technology.

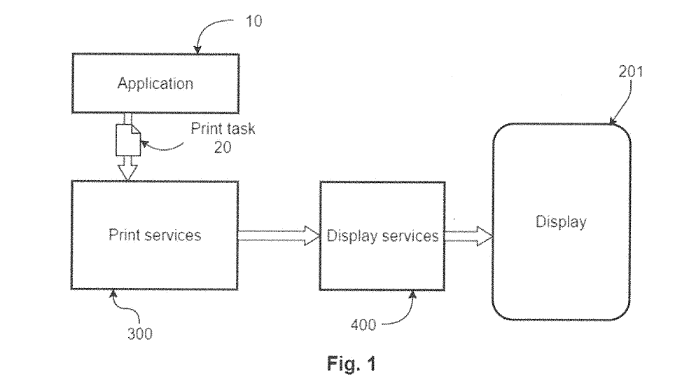

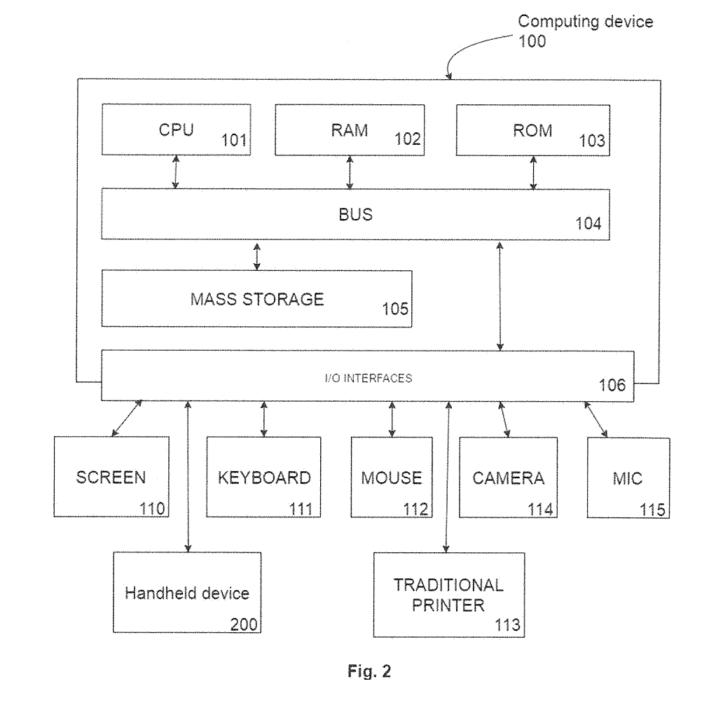

### DETAILED DESCRIPTION

The word “printer” is used in the description to refer to all kind of devices able to present a plurality of visually perceptible elements. This includes a conventional paper printers as well as handheld devices, but any other devices capable of displaying visually perceptible elements are within the scope of the invention.

The verb “to print” in all forms is used in the description to refer to the whole process leading to presenting a plurality of visually perceptible elements on a printer.

According to one aspect of the invention the print services 300 reside in a computing device 100. The computing device 100 may comprise a central processing unit (CPU) 101, random access memory (RAM) 102, read only memory (ROM) 103, mass storage 105 (e.g. hard drive) and input/output interfaces 106 all interconnected by a common communication bus 104. I/O interfaces 106 may comprise a set of different interfaces providing means of communication of the computing device 100 with external devices. For those skilled in the art it is understandable, that this may include many different types of wired or wireless interfaces including, but not limited to: USB, Firewire, RS232, parallel port, HDMI, DVI, VGA monitor port, Bluetooth. The I/O interfaces 106 may also include networking interfaces including, but not limited to: WiFi (e.g. IEEE 802.11) or Ethernet. The foregoing types of interfaces are given as an example only, as any means of one or bi-directional communication with external devices are within a scope of the invention. The external devices connected to the computing device 100 through I/O interfaces 106 may comprise a screen 110, keyboard 111, mouse 112, conventional paper printer 113, camera 114, microphone 115 or a handheld device 200. One skilled in the art understands that the above list is only exemplary.

One skilled in the art understands also, that the computing device must not necessarily include all the presented elements. For example, the invention could work also with a computing device 100 not including ROM 103 or mass storage 105.

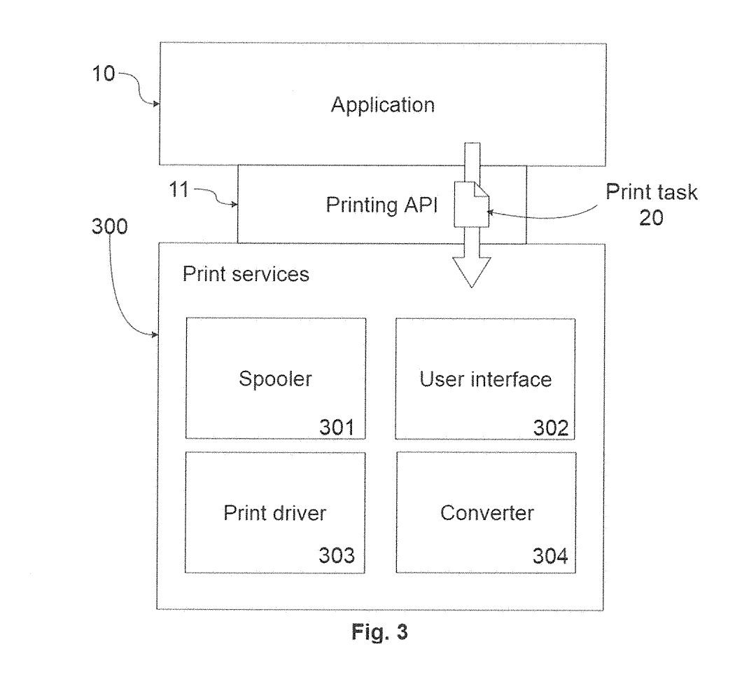

The computing device 100 may be a personal computer, a laptop, a notebook, a desktop computer, a workstation, a server, a tablet, a mobile phone or any other device on which a computer-implemented application can be run. According to one embodiment of the invention, the print services 300 are implemented as software running on a processor (CPU) 101 being part of a computing device 100. A possible embodiment of the print services is illustrated in FIG. 3.

A computer-implemented application 10 may be any kind of software capable of producing an output in a form of a printout. Non-limiting examples of such computer-implemented applications are: a word processor, a spreadsheet, an accounting software, a web browser, a graphics editing software, a CAD software. The computer-implemented application 10 can run on the same computing device 100 as the print services 300. Alternatively, the print services 300 may reside on a separate device playing a role of a print server.

The computer-implemented application 10 communicates with print services 300 through a Printing API 11. The Printing API 11 provides the computer-implemented application 10 with functions that the computer-implemented application 10 may call to access the print services 300—either to send or receive data from the print services. The computer-implemented application 10 invokes commands from the printing API 11 to send a print task 20 to the print services 300.

The print task 20 contains the content of the document being printed as well as control information. The main purpose of a print task 20 is to define a plurality of visually perceptible elements that are to be presented on a printer 113 or a handheld device 200. As the print task 20 is send through different print services up to the handheld device 200 or a printer 113, the format of the data in the print task can be changed, some data can be added and some data removed, which are no longer needed at a given stage of processing.

The print services 300 may comprise the following elements: spooler 301, user interface 302, print driver 303 and converter 304.

The spooler 301 creates a temporary file containing the print task 20, for further processing in the system, until the print task will be sent to a printer. It can also be responsible for queueing the print tasks.

The user interface 302 provides a user with means to configure the print services 300 and print driver 303 settings. In configurations where the print services 300 reside on a computing device 100 running an operating system with graphical user interface, it can be implemented as a window providing a user with controls like buttons, checkboxes, editing boxes and similar.

The print driver 303 establishes a connection with a specific printer through I/O interfaces 106 and basing on the type of a printer, chooses a proper converter 304.

The converter 304 translates a device independent spool file into a device dependent format, appropriate to be further processed by the printer. In a specific embodiment of the invention, both formats—the input and output format from the converter—may be the same format e.g. a PDF or PostScript. In this specific configuration, the converter is not necessary. Alternatively, it can get the input file and after determining that the output format is exactly the same, provide the output file without any materially significant modifications.

The printer may provide a print driver 303 with status data (e.g. out of paper, out of toner, print finished etc.) which may be presented to the user through user interface 302.

For one skilled in the art it is understandable, that the print services 300 may also contain other services, not mentioned above. For example, print services 300 may comprise a language monitor to establish a full-duplex communication with bi-directional printers capable of providing status information. One skilled in the art understands also that not all elements presented in FIG. 3 are necessary for print services 300 to serve their main purpose. By print services one understands each possible configuration of software-only, hardware-only or combined software-hardware solutions, that are capable of receiving a print task from a computer-implemented application, determine a proper format for a printer the print task is supposed to be printed and sending the print task in the proper format to the printer. The print services may typically provide additional functions or services like spooling a print task, queueing print tasks, providing user interface for configuring the print services, but their presence is not essential from the point of view of the invention.

One skilled in the art understands that the way of providing print services 300 presented in FIG. 3 is given only as an example and does not have a restrictive nature. Many other variations of the print services are possible, containing elements providing the same or similar functions.

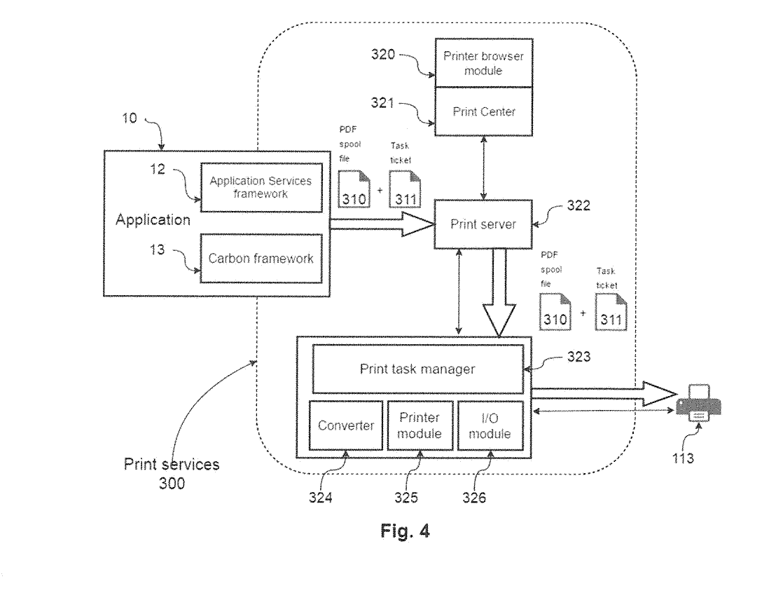

For example, an architecture of typical Max OS X print services may be used according to the invention, which is presented in FIG. 4. The base printing application programming interface (API) consist of Application Services framework 12 and Carbon frameworks 13. The print services 300 components include the print server 322, the Print Center application 321, and printer browser modules 320—among others. The print server 322 accepts print tasks from applications and holds each print task in a queue until the specified printer is available to print the print task. Print Center 321 provides a user interface to the print server 322, and can be used to view and manage print tasks in the printer queue. Print Center 321 also reports status, including errors, if any occur. Printer browser module 320 discovers printers that can be added to Print Center 321. The print task manager 323, converter 324, printer module 325 and the I/O module 326 work together to prepare and communicate a print task to a specific printer. In this embodiment, the print task consists of the drawing commands that describe a document (a spool file 310) and the settings (task ticket 311) that control and track the printing of a document once a print task has been added to a printer's queue. A print task starts as a series of drawing commands from a computer-implemented application, then is converted by the printing system to a portable document format (PDF) spool file 310 and a task ticket 311. A spool file 310 is a temporary disk file used to store the document's drawing as it travels through the printing system to the printer. The print task manager 323 accepts print tasks from the print server 322 and then mediates among the converter 324, printer module 325 and I/O module 326, to get the print task printed on a specific printer. A converter 324 is an optional module that converts a document description between different formats. The print task manager 323 determines how to convert the data properly for the chosen printer and configures the converter 324 appropriately. In general, a converter 324 takes a spool file 310 (which typically is PDF, but can be other format as well) and converts it to another output format, which may be for example raster, PostScript or any other format suitable for a particular printer. Printer modules 325 (which are analogous to printer drivers in other embodiments) are typically provided by printer vendors to support a particular printer type. One of the printer module's 325 functions is to determine the format of the data suitable for the particular printer. The printer module 325 communicates its needs to the print task manager 323, which uses the necessary converters 324 to get the print data in the correct format. The printer module 325 also handles printer status and error conditions. An I/O module 326 provides a way to communicate with printers using a standard interface. The interfaces can be of different types, for example LPR, USB or AppleTalk. The I/O module 326 establishes a connection with a printer, sends a document in a proper format to the printer along with commands, receives status information from the printer and closes the connection at appropriate time.

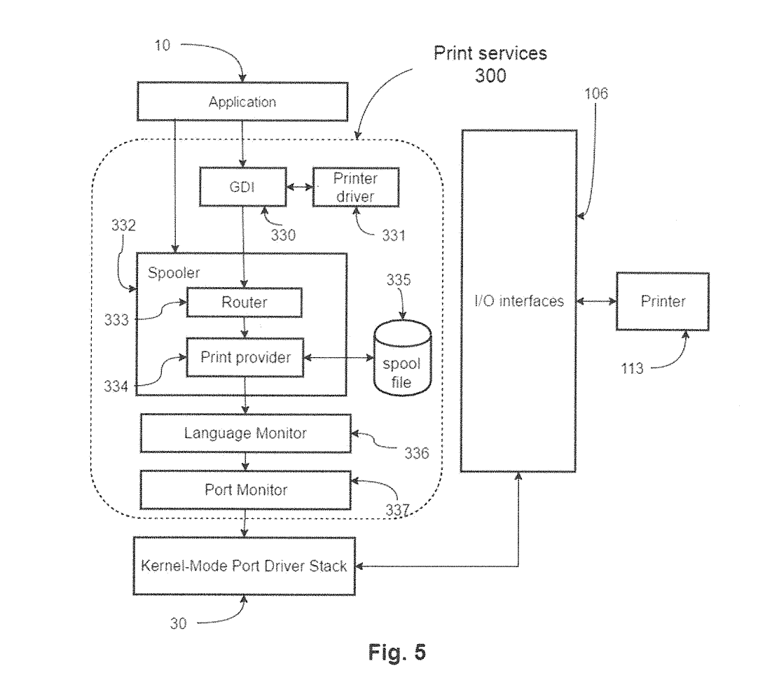

According to other embodiment of the invention also an example configuration of Windows print services may be used, which is presented in FIG. 5. Computer-implemented application 10 calls device-independent GDI functions in the Win32 API (not shown in FIG. 5). These functions pass the print task to the GDI graphics engine 330. In one possible embodiment, the GDI graphics engine 330 spools the drawing instructions as an enhanced metafile (EMF) file 335. In another possible embodiment, the GDI graphics engine 330 calls device-specific rendering functions provided by the print driver 331 to render a printable image and then sends the image to the spooler 332. The spooler consists of router 333 and one or more print providers 334. The router 333 chooses the appropriate print provider 334 by calling each print provider OpenPrinter function until one of them supplies a printer handle and a return value indicating the print provider recognizes the specified printer name. Print provider 334 role is to redirect the print task to local or remote print device. In one embodiment, the print provider 334 may also be responsible for print queue management operations, such as starting, stopping and enumerating a server's print queues. The print provider 334 passes the print task to the language monitor 336. The language monitor provides a full-duplex communications path between the print spooler and bi-directional printers that can provide software-accessible status information. In one possible embodiment, the language monitor 336 adds printer control information to the data stream. In one possible embodiment, the language monitor 336 may not be present and the print task is passed directly to the port monitor 337. The port monitor 337 can be responsible for management and configuration of the printer ports. It may also serve as a communication path between the print spooler 332 and the kernel-mode port drivers 30 that access the I/O interfaces hardware 106.

In a conventional paper printing architectures, the print services 300 send a print task 20 to a printer 113 through I/O interfaces 106. According to one aspect of the invention, instead of sending a print task 20 to the conventional paper printer 113, the print services 300 send the print task 20 to the display services 400 that communicates with a display 201. Thus, instead of on traditional paper, an image is created on a display 201 of the handheld device 200. This brings many benefits comparing to traditional paper, one of which is lack of paper and toner/ink consumption. Additionally, a lot of time is saved as displaying an image on a display is quicker than waiting for a physical printout.

The term “page” as used herein refers to the collection of content, defining the plurality of visually perceptible elements that are presented at one time on the display 201. The “pages” as described herein are not necessarily fixed permanently and the division of a document into pages can depend for example on the size of the font a user chosen to be used on the handheld device. The division of a document into pages may be done at many different stages of processing. One possible configuration involves a print services 300 to divide the document into pages according to the parameters of a display 201 provided by print driver 303. Another configuration involves dividing a document into pages by display services 400, before or during extraction of individual pages from the document to be sent to the display 201 of the handheld device 200.

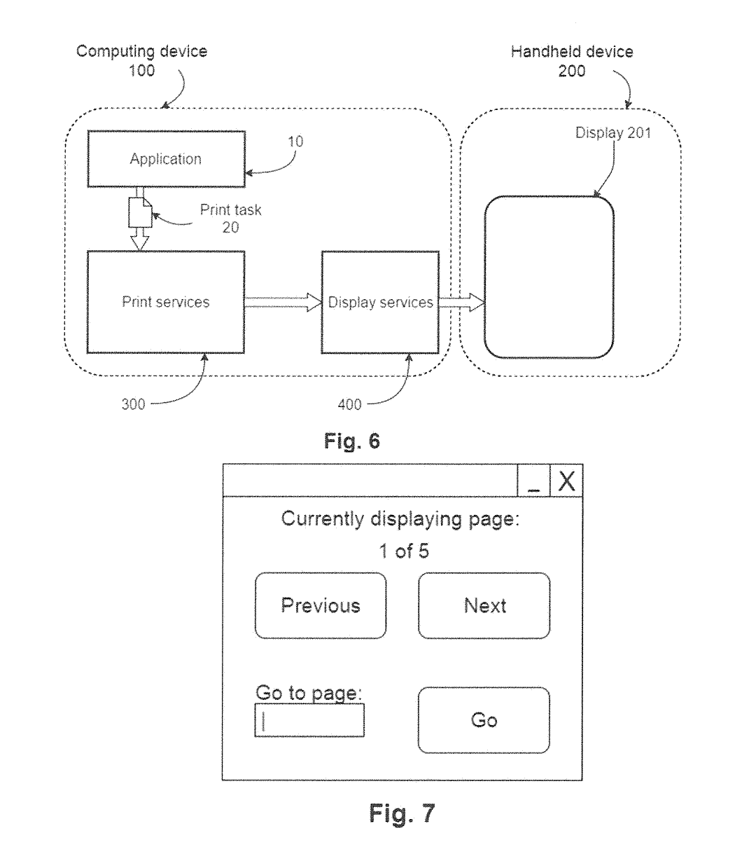

According to one embodiment of the invention, presented in FIG. 6, the display services reside in the computing device 100. One possible way of carrying out the invention is to implement it as a software module. The display services 400 are configured to communicate with print services 300 and the handheld device 200. The communication with print services 300 may be carried out for example through a localhost TCP/IP port, remote procedure calls (RPC) or any other means of local communication the print services support on a given computing device. The display services 400 are configured to communicate with a specific handheld device 200. The configuration may be constant or a specific handheld device may be chosen by a user.

A communication with handheld device 200 may be carried out by any means of communication appropriate for a given handheld device, for example, but not limited to: WiFi, Bluetooth or USB. After receiving the print task 20 from the print services 300, the display services 400 stores the print task 20 in a computing device's memory 102, extracts the first page of the document from the print task 20 and sends it to the handheld device 200 causing it to display the first page of the document on the display 201. After receiving the print task 20 from the print services 300 the display services display also a window providing means for receiving a command from a user. An example of such window is presented in FIG. 7. The window contains control elements, like buttons and spaces for text/number input. After receiving the command from a user through the window, the display services 400 separate an appropriate page (according to the command received from the user) and send it to the handheld device 200 causing it to display the page on the display 201. For example, when page no. 1 of a document is being displayed and a user clicks “Next” button, a page no. 2 will be displayed on the display 201 of the handheld device 200. It is also possible to input a specific page number in a “Go to page:” text edit field and after clicking “Go” button the specific page chosen by a user is displayed on the display 201 of the handheld device 200.

According to one embodiment of the invention, the first page of a document from a print task 20 is send to the handheld device 200 and displayed even before a complete print task 20 is received by the display services 400. The display services may extract the first page of a document from the print task 20 after receiving at least one page of the document and send it to the handheld device 200. This speeds up the response of the handheld device 200 as perceived by its user, improving a user experience. In this particular configuration, the handheld device 200 may lack memory, as no additional pages, except the one being displayed at a given moment needs to be stored in the handheld device. The handheld device can contain a bi-stable display that after driving it with appropriate signals can sustain an image without providing it with further signals, powering and thus a memory is not needed also to sustain an image on the display.

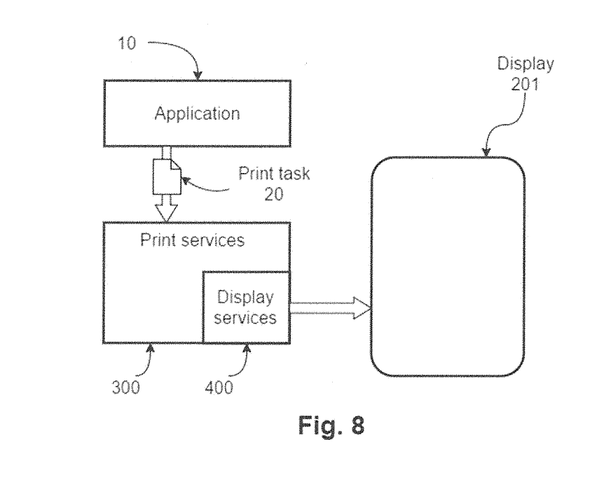

According to another possible embodiment of the invention, presented in FIG. 8, the display services 400 are one of the print services 300. They can be for example implemented as part of a Language Monitor 336. In this configuration, the spooler 332, being one of the print services 300, sends the print task to the language monitor 336 that displays a window such as presented in FIG. 7. The first page of the document from the print task is send further to the port monitor 337 and consequently to the handheld device 200 after receiving one or more pages of the document. After receiving a command from a user, e.g. after a user clicked a “next” button in the window presented in FIG. 7, the other page—selected by a user—is send and displayed on the handheld device 200.

Although the term “window” is used in the description for the clarity, it is understood for one skilled in the art that any kind of user interface capable of receiving a command from a user is within a scope of the invention.

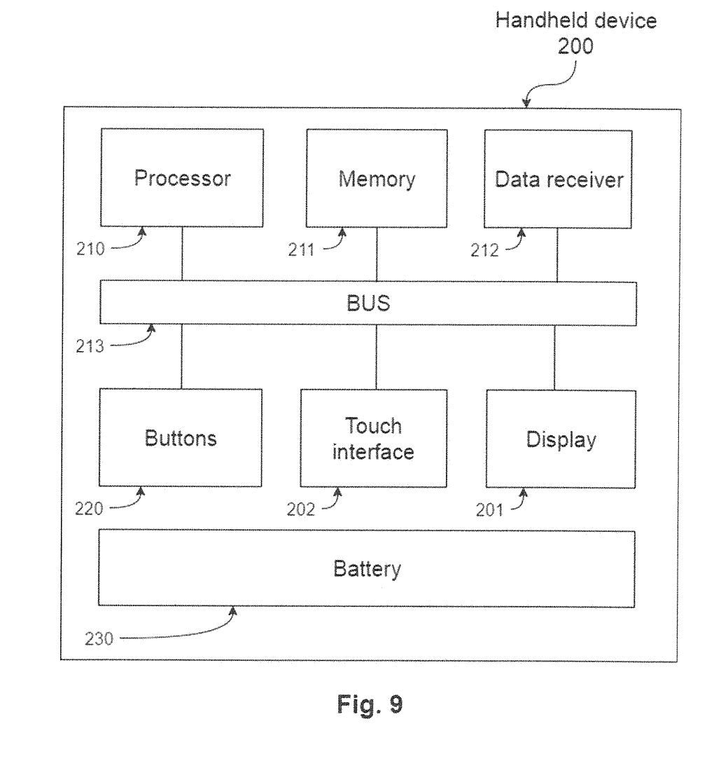

An exemplary configuration of the handheld device 200 is presented in FIG. 9. The handheld device 200 comprises a processor 210, a memory 211, a data receiver 212, buttons 220, a touch interface 202 and a display 201 all interconnected by a common communication bus 213.

The handheld device 200 can comprise also a battery 230 to provide power to the foregoing elements. The battery 230 may be for example a lithium-ion battery but any other type of battery is also within a scope of the invention.

The memory 211 can be a random-access memory (RAM), read only memory (ROM) or mass storage memory like for example flash memory, or any combination of the types of the memories mentioned. For one skilled in the art it is understandable that any type of memory is within the scope of the invention.

The data receiver 212 is configured to receive data from the print services 300 residing in the computing device 100. It can utilize any means of wired or wireless communication, for example, but not limited to: WiFi, Bluetooth or USB. Although this element of the handheld device 200 is named a “data receiver” one skilled in the art understands that except receiving data it may also be typically capable of sending data the other direction. The data receiver can be typically carried out a combination of hardware chipset and software running on the processor 210 of the handheld device 200, although any other hardware-only or software-only configuration are also within scope of the invention. In case the data receiver is configured for wireless communication it may comprise an antenna.

The display 201 may be a liquid crystal display (LCD), light emitting diode (LED) display, electrophoretic display, cholesteric display or any other type of display which is known in the art.

According to one aspect of the invention, the display 201 is electrically active, which means that the display 201 typically comprises a display circuitry (not shown) that comprise an interface between the bus 213 and the physical means of creating an image on the display 201. The display circuitry converts the data received into electrical signals that drives the display 201 to create an image.

According to one aspect of the invention, the display 201 is reflective, which means that is does not emit light on its own and an image is visible on the display 201 only in an external, ambient light reflected from the display 201 surface. This gives an experience similar to the conventional paper.

According to one of possible embodiments of the invention the display 201 is thin and flexible. One of many ways of carrying out a flexible display according to the invention is to use a polyimide plastic Thin-Film Transistor (TFT) backplane, which is laminated to the ink layer. The ink layer can be made of micro-capsules containing electrically charged white and black ink particles. The TFT backplane provides an electric charge to the specific places of the display causing either the black or white particles in the micro-capsules to move to the front surface of the display. This way an image is created on the display surface. As both the ink layer and polyimide plastic TFT backplane are flexible, the whole display screen is fully flexible—which gives an experience like using a sheet of traditional paper. The protective layer made of flexible material such as plastic may be included on the front of the flexible display.

The handheld device 200 may also include buttons 220. The buttons 220 may typically comprise a dedicated circuitry having an interface between the buttons 220 and the bus 213. At least some of the buttons 220 can be used to receive a command from a user that causes the display 201 to display another page of a document.

Alternatively or additionally to the buttons 220, the touch-screen interface 202 may be used to receive command from the user. The touch-screen interface 202 may be implemented for example in a form of a resistive, touch sensitive film with a dedicated circuitry having an interface between the touch sensitive film and the bus 213. In this case, a user gesture like swiping the finger from left to right may be detected and interpreted as a command to display a next page and swiping the finger from right to left may be detected and interpreted as a command to display a previous page.

The physical embodiment of the handheld device 200 depends on if the device is to be flexible or not.

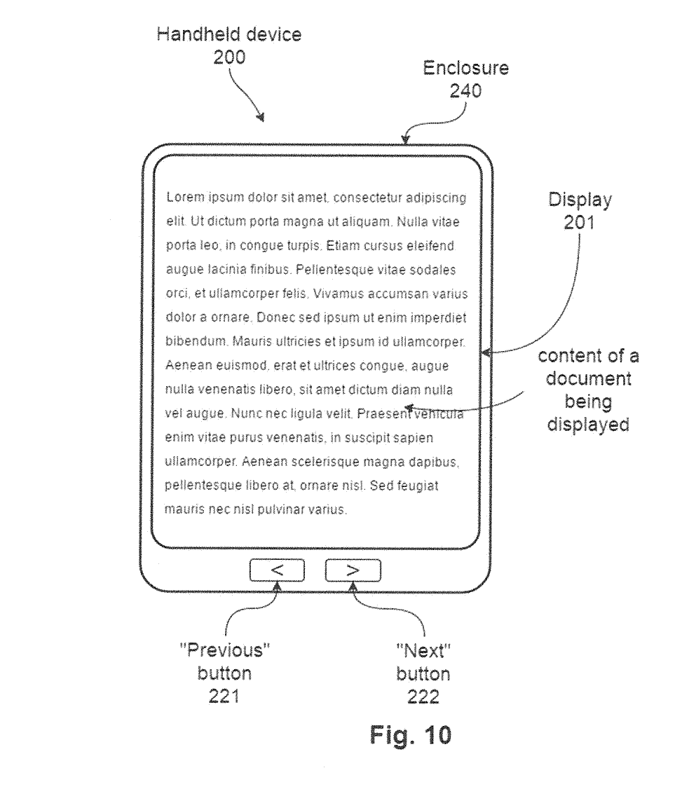

An exemplary embodiment of non-flexible physical construction of the handheld device 200 is presented in FIG. 10. The enclosure (made e.g. of plastic) 240 encloses the display 201, buttons 221, 222 and all other elements not shown in the figure, including, but not limited to: the battery 230, the processor 210, the memory 211, the data receiver 212, and the bus 213. The touch-sensitive layer may be included as a front, back or middle layer of the display screen, which is not shown in the figure.

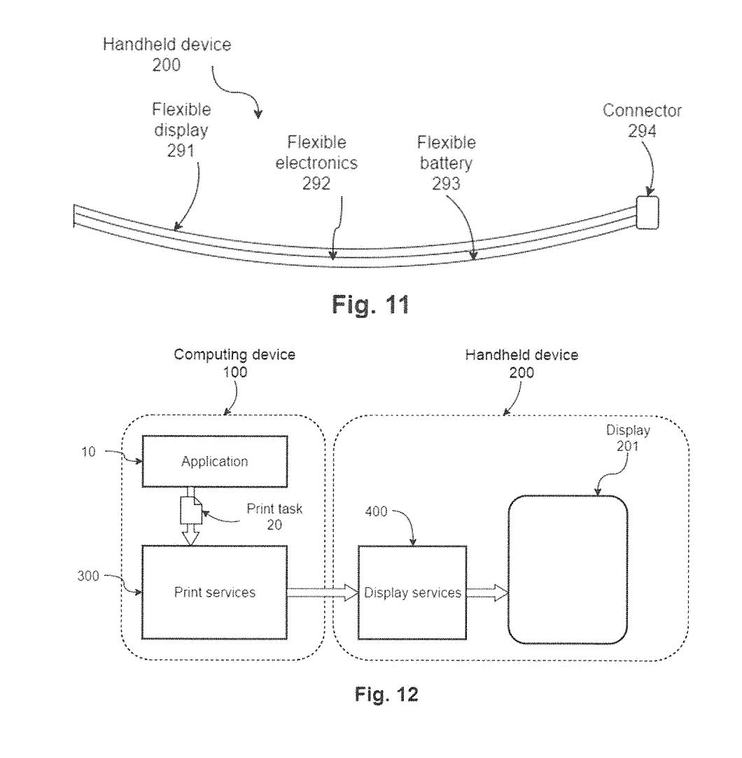

An exemplary embodiment of a flexible construction of the handheld device 200 is presented in FIG. 11. The handheld device 200 consists of flexible display 291, flexible electronics 292, flexible battery 293 and the connector 294.

The flexible display 291 may be carried out as a polyimide plastic TFT backplane laminated to the ink film.

The electronic elements of the handheld device 200, including the processor 210, the memory 211, the data receiver 212, the buttons 220 circuitry, the touch interface 202 circuitry, the bus 213, are implemented in a form of flexible electronics 292. One skilled in the art understands that there are many methods of carrying out the flexible electronics known in the art. An exemplary technology to implement the flexible electronics according to this aspect of the invention is based on organic thin-film transistors (OTFT) combined with passive elements manufactured on flexible plastic film. The flexible plastic substrates such as polyimide, PEEK or transparent conductive polyester film can be used alternatively. These technologies are commercially available for example from FlexEnable or Plastic Logic.

For a handheld device 200 to be fully flexible the battery 293 also must be flexible. In a possible embodiment of the invention, the battery 293 can be made by winding two carbon nanotubes-lithium oxide composites yarns, which serve as the positive and negative electrodes, onto an elastomer substrate and covering this with a layer of gel electrolyte. Alternatively, the flexible battery 293 can be carried on as Li₄Ti₅O₁₂-CNT and LiCoO₂-CNT composites formed by coating electrode active materials onto carbon nanotubes. One skilled in the art understands, that any kind of battery that is flexible could be used in the handheld device 200 within the scope of the invention.

The connector 294 may be a non-flexible element allowing to connect a power supply cable to recharge the battery. For example, a standard micro-USB connector may be used to work with many widely used mobile phone chargers.

An alternative embodiment of the invention lacks the non-flexible connector 294, making the whole handheld device flexible. In this configuration, the inductive charging of the battery can be used, that transfers energy between the charger and the handheld device wirelessly through electromagnetic induction.

One skilled in the art understands, that the configuration of the handheld device 200 presented above is only exemplary and many other ways of carrying out a handheld device and configuration of a handheld device are within a scope of the invention. For example, the handheld device may lack some of the presented elements—like buttons 220, touch-interface 202 or both. It may also contain additional elements not mentioned in the description (like for example a microphone or camera) without harm to the nature and scope of the invention.

According to one embodiment of the invention, presented in FIG. 12, the display services 400 are the element of the handheld device 200. The display services 400 can be implemented for example within an architecture of the handheld device presented in FIG. 9 and described above.

According to one of possible embodiments, the display services 400 are a combination of software and hardware, utilizing at least the following elements of the handheld device 200: buttons 220, memory 211, processor 210 and data receiver 212. The data receiver 212 is configured to receive print task from a computing device 100. After receiving it, the print task is stored in the memory 211 and the first page from the document is extracted and send to the display 201, which cases the display 201 to display the first page of the document. After a user presses a button, for example “next” 222 or “previous” 221 button, it is interpreted as a command to display another page of the document. The appropriate page of the document is extracted from the print task and read from the memory 211 and send to the display 201 that causes it to display another page of the document. For example, if the display 201 is displaying a page no. N and a user presses the “next” button 222, a page no. N+1 is being extracted from the print task stored in the memory 211 and displayed on the display 201. Alternatively, if a user presses the “previous” button 221, a page no. N−1 is being extracted from the print task stored in the memory 211 and displayed on the display 201. The processor 210 executes the instructions stored in the memory 211 that causes the above-described operations to be performed.

According to another possible embodiment, the display services' buttons 220 from the foregoing embodiment can be replaced by touch interface 202. All other things being the same, this embodiment differs in a way a command is provided by a user. For example, a user's gesture of swiping a finger from left to right can be interpreted as a command to display a page no. N−1 and a gesture of swiping a finger from right to left can be interpreted as a command to display a page no. N+1.

In each of the described embodiments the display services 400 convert the plurality of visually perceptible elements in the format as received from print services 300 (input format) to another format (output format), the output format sizing the plurality of visually perceptible elements relatively to the size of a display 201 of the handheld device 200, so that the plurality of visually perceptible elements fit on the display in relative sizes and positions identical as the plurality of visually perceptible elements would have appeared on a paper substrate.

In some embodiments, the output format can be a bitmap representing the color of each individual pixel as they should appear on the display 201. In this embodiment, the bitmap is read by display circuitry that converts it to electrical signals driving the physical means of creating an image from individual pixels on the display. Although the bitmap format is described here as an exemplary output format, one skilled in the art understands, that many other output formats are within the scope of the invention.

The conversion from the input format to the output format may be done either before or after dividing the document into individual pages, depending on the particular embodiment of the invention.

In some embodiments, additional conversions can occur in between e.g. the input format being converted to a temporary format and then the temporary format being converted to the output format. One skilled in the art understands, that more than one temporary format can be used and additional conversions between the temporary formats can occur in the display services without departing from the nature and scope of the invention e.g. the input format being converted to a temporary format 1, being converted to a temporary format 2, being converted to the output format.

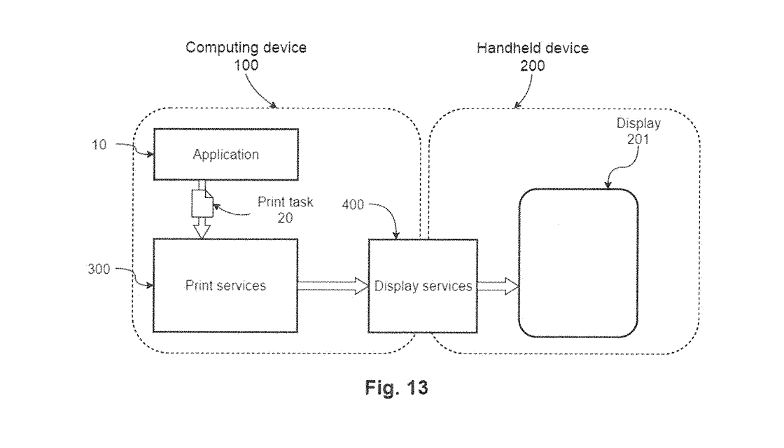

According to one particular embodiment of the invention, presented in FIG. 13, part of the display services 400 reside in the computing device 100, while another part of the display services reside in the handheld device 200. In this embodiment, the display services residing in the computing device 100 may receive the print task from print services 300, provide a user with control elements for selecting a page to be displayed on the display 201, e.g. in a form of a window like presented in FIG. 7, receive commands from the user and divide a document from the print task to the individual pages. The display services residing in a computing device 100 may send the page to be currently displayed on the display 201 to the handheld device 200 through the I/O interfaces 106 in a format as received from the print services 300 (input format). The display services residing in the handheld device 200 may receive the page to be displayed in the input format through the data receiver 212, converts it to the output format (e.g. the bitmap) and cause the page in the output format to be displayed on the display 201. One skilled in the art understands, that the above presented division of functions of the display services between the computing device 100 and the handheld device 200 is only given as an example and any other division is also within a scope of the invention.

The foregoing Detailed Description is to be understood as being in every respect illustrative and exemplary, but not restrictive, and the scope of the disclosed technology disclosed herein is not to be determined from the Detailed Description, but rather from the claims as interpreted according to the full breadth permitted by the patent laws. It is to be understood that the embodiments shown and described herein are only illustrative of the principles of the disclosed technology and that various modifications may be implemented by those skilled in the art without departing from the scope and spirit of the disclosed technology. Those skilled in the art could implement various other feature combinations without departing from the scope and spirit of the disclosed technology. Although the embodiments of the present disclosure have been described with specific examples, it is to be understood that the disclosure is not limited to those specific examples and that various other changes, combinations and modifications will be apparent to one of ordinary skill in the art without departing from the scope and spirit of the disclosed technology which is to be determined with reference to the following claims.

What is claimed is:

1. A system comprising:
(a) a computing device having print services installed thereon;
(b) at least one handheld device, being in wireless communication with the computing device; and
(c) display services,
the print services programmed to:
(i) receive a print task in a first format from an application being operated by the computing device, the print task defining a plurality of visually perceptible elements;
(ii) determine a second format for the plurality of visually perceptible elements appropriate for receipt by display services;
(iii) convert the plurality of visually perceptible elements included in the print task from the first format to the second format, if the first format is different than the second format;
(iv) send the plurality of visually perceptible elements in the second format to the display services;
and the display services programmed to:
(i) receive the plurality of visually perceptible elements in the second format;
(ii) convert the plurality of visually perceptible elements in the second format into a third format, the third format sizing the plurality of visually perceptible elements relatively to the size of a display of the handheld device, so that the plurality of visually perceptible elements fit on the display in relative sizes and positions identical as the plurality of visually perceptible elements would have appeared on a paper substrate;
(iii) display a first page of the plurality of visually perceptible elements on the display of the handheld device; and
(iv) after receiving a next page command, display a next page of the plurality of visually perceptible elements on the display of the handheld device.

2. The system of claim 1 wherein the display is a flexible display.

3. The system of claim 2 wherein the flexible display includes a polyimide plastic Thin-Film Transistor (TFT) backplane, which is laminated to an ink layer.

4. The system of claim 1 wherein the display includes a touch-sensitive layer.

5. The system of claim 1 wherein the display includes a graphical user interface having control buttons.

6. The system of claim 4 wherein the plurality of visually perceptible elements are divided into one or more pages for presentation.

7. The system of claim 6 wherein the next page command is performed with a swipe function of the touch-sensitive layer.

8. The system of claim 1 wherein the wireless communication is one of WiFi or Bluetooth.

9. The system of claim 1 wherein the at least one handheld device includes a flexible battery.

10. The system of claim 9 wherein the flexible battery is made using multiple pairs of carbon nanotubes-lithium oxide composites yarns, each pair being wound together.

11. A handheld device, comprising:
(a) a display;
(b) a wireless communication module; and
(c) display services, the display services configured to:
(i) receive a plurality of visually perceptible elements in a first format from print services installed in a computing device;
(ii) convert the plurality of visually perceptible elements in the first format into a second format, the second format sizing the plurality of visually perceptible elements relatively to the size of the display, so that the plurality of visually perceptible elements fit on the display in relative sizes and positions identical as the plurality of visually perceptible elements would have appeared on a paper substrate;
(iii) display a first page of the plurality of visually perceptible elements on the display of the handheld device; and
(iv) after receiving a next page command, display a next page of the plurality of visually perceptible elements on the display of the handheld device.

12. The system of claim 11 wherein the display is a flexible display.

13. The system of claim 12 wherein the flexible display includes a polyimide plastic Thin-Film Transistor (TFT) backplane, which is laminated to an ink layer.

14. The system of claim 11 wherein the display includes a touch-sensitive layer.

15. The system of claim 11 wherein the display includes a graphical user interface having control buttons.

16. The system of claim 14 wherein the plurality of visually perceptible elements are divided into one or more pages for presentation.

17. The system of claim 16 wherein the next page command is performed with a swipe function of the touch-sensitive layer.

18. The system of claim 11 wherein the wireless communication module is one of WiFi or Bluetooth.

19. The system of claim 11 wherein the at least one handheld device includes a flexible battery.

20. The system of claim 19 wherein the flexible battery is made using multiple pairs of carbon nanotubes-lithium oxide composites yarns, each pair being wound together.
